(19) United States
(12) Patent Application Publication
(10) Pub. No.: US 2006/0130341 A1
(43) Pub. Date: Jun. 22, 2006

(54) Saw blade and a hand saw

(76) Inventors: James Michael Burry, Troutman, NC (US); Robert Field, Munchen (DE); Manfred Geier, Puchheim (DE); Daniel R. Seymour, Mooresville, NC (US)

Correspondence Address: MOORE & VAN ALLEN PLLC, P.O. BOX 13706, Research Triangle Park, NC, 27709, US

(21) Appl. No.: 11/214,081

(22) Filed: Aug. 29, 2005

(30) Foreign Application Priority Data
Dec. 17, 2004 (DE) 10 2004 060 974.8

(51) Int. Cl. B26B 9/02

(52) U.S. Cl. 30/166.3; 30/355

(57) ABSTRACT

A saw blade, especially for a handsaw, along the longitudinal edge of which a series of saw teeth is formed which has a geometric saw-tooth base line extending along the saw blade and is divided by at least one tooth gap, preferably a plurality of tooth gaps, into sections of the series comprising a plurality, especially more than two saw teeth, a free space of recessed saw blade material in the area of a tooth gap and extending beyond the saw-tooth base line into the saw blade being provided with an undercut.

### BACKGROUND

The instant invention relates to a saw blade, especially for a handsaw which is movable back and forth and has a series of saw teeth formed along its longitudinal edge. The geometry of the saw teeth normally is identical along the longitudinal edge. However, saw teeth of different saw-tooth geometries likewise may be provided along the saw blade in accordance with the invention.

A geometric saw-tooth base line extending along the saw blade and derived from imaginary connecting lines between adjacent roots of teeth may be associated with a series of teeth. This saw-tooth base line may extend in parallel with the longitudinal extension of the series of saw teeth, albeit not necessarily. The invention, for example, also relates to series of saw teeth whose teeth have different saw-tooth heights. In that case, the geometric saw-tooth base line is to be understood as being an assumed straight line of a mean saw-tooth base line. The sawing efficiency of a handsaw is determined by various parameters, such as the cutting depth achievable by a saw stroke with identical sawing force.

It is an object of the invention to improve the sawing efficiency of a saw blade for a handsaw without having to apply greater sawing force, without having to put up with impaired ergonomic functionality in consideration of ease in manufacturing the saw, and without having to modify the known saw-tooth geometries as such.

### SUMMARY OF INVENTION

Thus the series of saw teeth is divided by at least one tooth gap, preferably a plurality of tooth gaps between two sections of a series comprising a plurality of saw teeth, especially more than two saw teeth. A free space of recessed saw blade material is formed according to the invention in the area of at least one tooth gap so as to extend into the saw blade at least beyond the saw-tooth base line, above all beyond the saw tooth base of the teeth adjacent the tooth gap. Tests have shown that the provision of such a free space in the saw blade makes it possible to clearly increase the amount of chips to be cut of the article being sawed at constant sawing force. Surprisingly, it was found that the free spaces contribute to conveying the saw dust produced by the saw teeth through the free space out of the cutting groove. Also, when exiting the cutting groove, the sawdust can fall out of the free space under the influence of their own. According to the invention the free space includes at least one undercut providing distinct enlargement of the volume defined by the free space for receiving sawdust while, at the same time, not reducing the resistance of the saw blade to buckling and bending, or only marginally so. The undercut may be defined by a free space area which extends from the tooth gap beyond the geometric saw-tooth base line in longitudinal direction.

The free space formed beyond the saw-tooth base line as an undercut with a longitudinal directional component of the saw blade may reach across part of the area of a series section adjacent a tooth gap, preferably of both adjacent series section.

In a further development of the invention, the tooth gap tapers, especially continuously, up to the saw-tooth base line. In this manner it is assured that the sawdust produced will always find its way into the free space by virtue of the converging, funnel-shaped tooth gap, thus being transported out of the cutting groove. Preferably, the tooth gap is defined by tooth flanks of adjacent saw teeth.

With a preferred embodiment of the invention, the free space widens, especially continuously, essentially from the level of the saw-tooth base line in the direction of the interior of the saw blade. A maximum widening angle of the free space may be in the order of at least 30°, preferably about 90° and, in particular, be greater than a maximum opening angle of the tooth gap.

Unimpeded access of the sawdust from the tooth gap into the free space is obtained by the tooth gap and the free space preferably merging one into the other so as to present a common recess in which, in particular, includes a constriction essentially at the level of the saw-tooth base line. This constriction makes sure that sawdust received in the free space during alternating movements of the handsaw away from the article to be cut will not readily fall back from the free space into the cutting groove where they could hamper the freedom of movement of the saw blade. The constriction must be configured such that the removal of the saw blade form the cutting groove of the article being sawed will allow the sawdust received in the free space to fall out readily under the influence of its weight.

Designing the recess which defines the tooth gap and the free space in the shape of a boot proved to be a particularly effective means of discharge from the recess, resulting in an exceptionally high sawing performance of the saw blade. With this configuration, a heel portion of the free space of the boot-like recess may be facing a free-end face of the saw blade, while a toe portion of the free space faces a grip-end face of the saw blade.

Tests have shown that very good removal of sawdust can be obtained if the longitudinal (with respect to the saw blade) depth of the undercut corresponds at least to one fourth of the average tooth height of the series of teeth. It was found that the upper limit of the longitudinal depth of the undercut should correspond, at most, to the average saw-tooth height. In a preferred embodiment of the invention, the longitudinal depth of the undercut essentially equals half the average saw-tooth height.

In a further development of the invention, the free space includes a first undercut facing a free-end face of the saw blade and a second undercut remote from the free-end face of the saw blade. Especially the second undercut is located at a greater distance from the saw-tooth base line than the first undercut. The first undercut preferably has a depth of approximately one third of the average saw-tooth height, while the second undercut has a depth of approximately half the height of a saw tooth.

Particularly good sawing results were achieved when the depth of the free space from the saw-tooth base line was substantially the same as an average saw-tooth height of the series of saw teeth.

In a preferred further development of the invention the free space is formed like a channel, and the channel-like free space extends into the saw blade at an inclination with respect to the saw-tooth base line. The channel-like free space may extend at an acute angel of from 15° to 75°, preferably approximately 30° with respect to the saw-tooth base line. It was found to be especially advantageous if the channel-like free space, in its course to a grip-end face of handsaw, extends in upward direction with respect to the saw tooth-base line.

The invention, moreover, relates to a handsaw comprising a saw blade according to the invention. A handsaw is characterized in that it is operated manually and the sawing motion is alternating. The saw blade may be provided with any kind of saw-tooth geometry, such as triangular tooth geometry, ripping or cleaving saw geometry, series of teeth wrenched in alternate directions or sinuous teeth.

Other advantages, properties, and characteristics of the invention will become apparent from the description below a preferred embodiment and from the accompanying drawings.

### BRIEF DESCRIPTION OF THE DRAWINGS

FIG. 1 is a side elevational view of a saw blade according to the invention for a handsaw; and

FIG. 2 is an enlarged side elevation showing in detail the part marked A in FIG. 1.

### DETAILED DESCRIPTION OF PREFERRED EMBODIMENTS

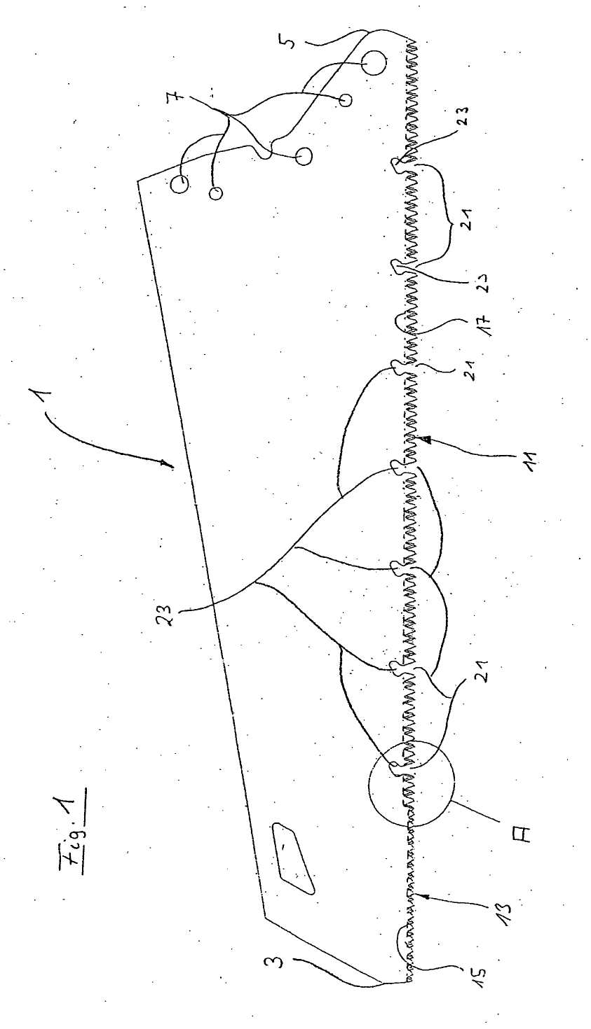

In FIG. 1 a saw blade according to the invention is designated by reference numeral 1. It has a free-end face 3 and a grip-end face 5 formed with bores 7 for attaching, especially removably, a grip (not shown).

The saw blade 1 comprises two series of saw teeth 11 and 13 along one straight longitudinal edge. Series of saw teeth may be provided at the opposite longitudinal edge of the saw blade 1 as well. The series 11 of coarse saw teeth and small pitch (9 teeth per inch (25.4 mm)) is designed to cut large amounts of chips and extends from the grip-end face 5 through and beyond a central portion into the zone of the free-end face 3 of the saw blade 1.

The series 13 of fine teeth and greater pitch (12 teeth per inch (25.4 mm)) is formed with smaller teeth, especially of like geometry. That facilitates initial cuts into an article (not shown) which is to be sawed.

The series 11 of coarse teeth and the series 13 of fine teeth each have a saw-tooth base line 15 and 17, respectively, illustrated in discontinuous lines and corresponding to a geometric line which connects the roots of the teeth.

The series of coarse teeth is subdivided by seven tooth gaps 21 into six identical sections of twelve successive saw teeth of identical tooth geometry.

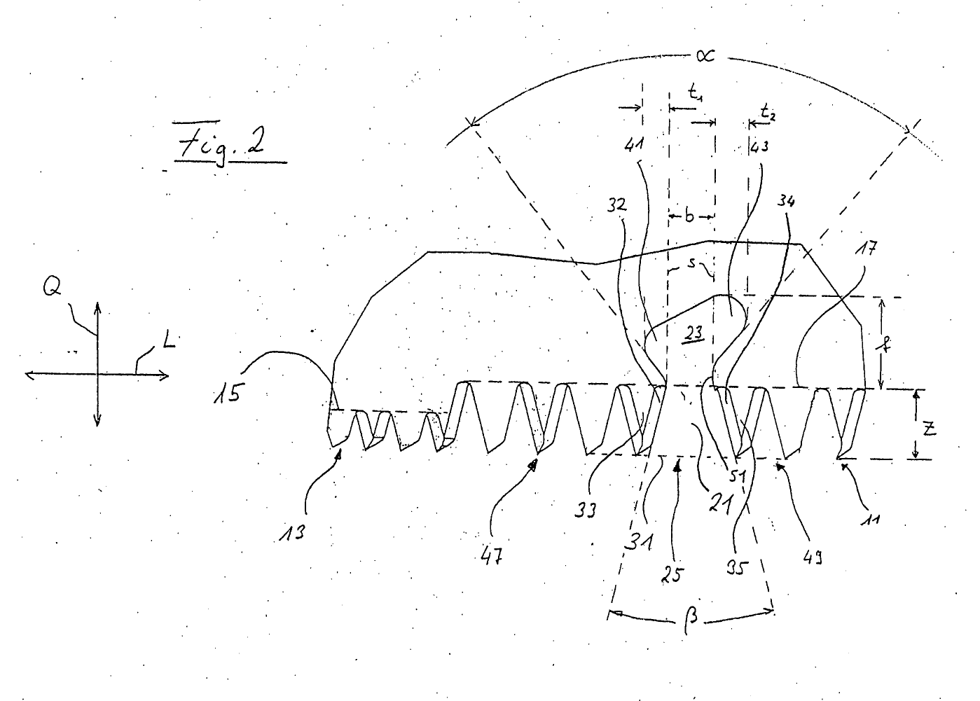

Next to the tooth gap, at the level of the saw-tooth base line 15, there is a free space 23 which extends mainly in transverse direction Q of the saw blade 1 and serves to receive sawdust cut from the article, out of the cutting groove (not shown). The recess or cutout 25 of the saw blade material defined by the tooth gap 21 and the free space 23 will be described in greater detail with reference to FIG. 2.

The tooth gap 21 converges continuously from a saw-tooth head line 31 to the saw-tooth base line 15. The tooth gap 21 is defined by the tooth cutting flanks 32, 34 of adjacent teeth 33 and 35.

The width b at the base of the tooth gap substantially corresponds to the width of a saw tooth 33, 35 at its root. The free space 23 comprises two undercuts 41 and 43 which extend, with a longitudinal directional component of the saw blade, in undercutting fashion partly across the area of a section 47, 49 of the series of teeth adjacent the tooth gap 21. The free space 23 widens at a maximum widening angel α of approximately 90°, as seen from the saw-tooth base line 17 into the interior of the saw blade.

It should be noted that the free space 23 has no edges or corners, just rounding so as to obstruct the sawdust produced from falling out of the free space 23 as the saw is moved out of the cutting groove of the article (not shown) on which it worked.

In the recess 25 defined by the tooth gap 21 and the free space 23 a constriction 51 is formed essentially at the level of the saw-tooth base line 15.

A maximum opening angle β of the tooth gap is set at essentially 30°. The free space 23 comprises a first undercut 41 associated with a free-end face 3 of the saw blade and having an undercut depth t₁ of essentially one third of the average tooth height of the series 11 of saw teeth. In the embodiments illustrated in FIGS. 1 and 2, this is equal to the constant tooth height Z of the entire series 11 of saw teeth. The second undercut 43 has an undercut depth t₂ corresponding essentially to the average tooth height. The depth of the undercuts result from the greatest distance of the edge of the undercut in longitudinal direction L of the saw blade 1 from a vertical line s at the level of the constriction 51.

The depth f of the free space 23 results from the greatest distance of an edge of the free space in traverse direction Q of the saw blade with respect to the saw-tooth base line from the longitudinal direction of the saw blade 1. Essentially, the depth f equals the average saw-tooth height Z. As may be gathered especially from FIG. 2, the free space 23 partly forms a channel which extends obliquely upwardly with respect to the saw-tooth base line 15, as seen from the free-end face 3 to the grip-end face 5.

It proved that the sawing efficiency of the saw blade 1 can be distinctly improved by the specific geometry described above of the tooth gap 21 and the free space 23. The free space 23 and the undercuts 41, 43 present a large volume to receive sawdust produced by engagement of the saw teeth in the article. As a consequence of the provision of the free space 23 with undercuts 41, 43, the chips removed from the article are transported from the cutting flanks of the saw teeth through the tooth gap away from the cutting groove so that sawdust cannot impede the cutting process.

When the saw blade 1 exits from the article being sawed the sawdust falls out of the free space 23 due, one the one hand, to the sawing movement of the saw blade and, on the other hand, its own weight. Therefore, the free space again can take up sawdust when the saw blade penetrates once more in the article.

While assuring a large take-up volume for sawdust, the undercut 41, 43 does not impair the strength of the saw blade 1 because of loss of material in the free space 23.

The features disclosed in the specification above, in the figures and claims may be significant for implementing the invention in its various embodiments, both individually and in any combination.

1. A saw blade, especially for a handsaw, along the longitudinal edge of which a series of saw teeth is formed which has a geometric saw-tooth base line extending along the saw blade and is divided by at least one tooth gap, preferably a plurality of tooth gaps, into sections of the series comprising a plurality, especially more than two saw teeth, a free space of recessed saw blade material in the area of a tooth gap and extending beyond the saw-tooth base line into the saw blade being provided with an undercut.

2. The saw blade as claimed in claim 1, wherein the free space which is recessed beyond the saw-tooth base line extends in undercutting fashion by a longitudinal directional component of the saw blade, especially a non-negligible one, across part of the area of an adjacent series section, preferably of both these sections.

3. The saw blade as claimed in claim 1, wherein the tooth gap tapers, especially continuously up to the saw-tooth base line, the tooth gap being defined especially by tooth flanks of adjacent saw teeth.

4. The saw blade as claimed in claim 1, wherein the free space widens, especially continuously, essentially from the level of the saw-tooth base line, preferably at a maximum widening angle (α) of at least approximately 30°.

5. The saw blade as claimed in claim 4, wherein the maximum widening angle (α) of the free space is greater than a maximum opening angle (β) of the tooth gap.

6. The saw blade as claimed in claim 1, wherein the tooth gap and the free space pass over one into the other, forming a recess which includes a constriction substantially at the level of the saw-tooth base line.

7. The saw blade as claimed in claim 1, wherein the recess is shaped substantially like a boot, in particular a heel portion of the free space being associated with a free-end face of the saw blade and a toe portion of the free space being associated with a grip-end face of the saw blade.

8. The saw blade as claimed in claim 1, wherein an undercut depth (t₁, t₂) corresponds to at least one fourth of the average saw-tooth height of the series of saw teeth.

9. The saw blade as claimed in claim 1, wherein an undercut depth (t₁, t₂) corresponds, at most, to the average saw-tooth height of the series of saw teeth, preferably equalling half of the average saw-tooth height.

10. The saw blade as claimed in claim 1, wherein the free space includes a first undercut facing a free-end face of the saw blade and a second undercut remote from the free-end face of the saw blade, the second undercut especially being located farther from the saw-tooth base line than the first undercut.

11. The saw blade as claimed in claim 10, wherein undercut volumes of the first and second undercuts are substantially the same, or the undercut volume of the second undercut is greater than that of the first undercut, preferably at least 1.5 times greater.

12. The saw blade as claimed in claim 1, wherein a depth (f) of the free space from the saw-tooth base line is substantially equal to the average saw-tooth height of the series of saw teeth.

13. The saw blade as claimed in claim 1, wherein the free space extends like a channel into the saw blade, obliquely with respect to the saw-tooth base line, especially at an acute angle of from 15° to 75°, preferably approximately 30°, the channel-like free space, in its course towards a grip-end face of the saw blade, extending into the saw blade especially in upward direction with respect to the saw-tooth base line.

14. A handsaw comprising a saw blade along the longitudinal edge of which a series of saw teeth is formed which has a geometric saw-tooth base line extending along the saw blade and is divided by at least one tooth gap, preferably a plurality of tooth gaps, into sections of the series comprising a plurality, especially more than two saw teeth, a free space of recessed saw blade material in the area of a tooth gap and extending beyond the saw-tooth base line into the saw blade being provided with an undercut.

15. The saw blade as claimed in claim 1 wherein said free space widens at a maximum widening angle (α) of 90°.
